(19) United States
(12) Patent Application Publication
(10) Pub. No.: US 2015/0005061 A1
(43) Pub. Date: Jan. 1, 2015

(54) DYNAMIC LOG-IN FROM MOBILE PHONE TO SET-TOP BOX

(71) Applicant: KABAM, INC., San Francisco, CA (US)

(72) Inventors: Clifford J. HARRINGTON, San Francisco, CA (US); Kent WAKEFORD, Hillsborough, CA (US)

(21) Appl. No.: 13/929,700

(22) Filed: Jun. 27, 2013

(51) Int. Cl. A63F 13/00

(52) U.S. Cl. CPC A63F 13/00
USPC 463/29

(57) ABSTRACT

Systems and methods for authenticating user accounts associated with an online game to users of presentation control devices and to enable the presentation control devices to present views of the online game corresponding to the authenticated user accounts.

### FIELD OF THE DISCLOSURE

This disclosure relates to systems and methods authenticating of one or more users of presentation control devices to user accounts hosted by a remote server, such that the presentation control devices may be enabled to present views of the virtual environment provided by the remote server and corresponding to the authenticated users.

### BACKGROUND

Online games can be enjoyed by users from a variety of media devices. The versatility of online gaming allows users to log into user accounts and play online games from nearly any device capable of network communication. When on-the-go, users can log in from their mobile devices such as smart phones, laptops, and other devices to user accounts associated with the online games to provide user access to their game account information corresponding to the account. User accounts may also be retrieved from presentation control devices, such as smart TV's and television set-top boxes. Users may input account information into the presentation control devices to log in and access users' accounts for playing online games. For example, presentation control devices may have internet access allowing users to input user account information into a web browser.

### SUMMARY

One aspect of the disclosure relates to a system for authenticating online game user accounts to users of presentation control devices. The user accounts may be associated with one or more remote servers which host the user accounts. The system may comprise one or more processors configured to execute computer program modules. The computer program modules may comprise one or more of a game module, a user module, a reception module, a correlation module, an authentication module, and/or other modules.

The game module may be configured to execute an instance of an online game. The instance of the online game may correspond to the user account associated with authenticated users of a presentation control device. The game module may implement the instance of the online game to facilitate participation of users in the online game through views of the online game presented to the users through presentation control devices and mobile devices.

The user module may be configured to manage user information associated with the users of the online game and presentation control devices. The user information may include user accounts comprising identification information and online game account information. The user accounts may include a first user account comprising first identification information and first game account information associated with a first user of a first presentation control device.

The reception module may be configured to obtain mobile device information from presentation control devices. The presentation control devices may be in communication with mobile devices associated with the users of the presentation control devices. The mobile device information may include first mobile device identification information obtained from the first presentation control device communicating with a first mobile device. The first mobile device may be associated with the first user.

The correlation module may be configured to correlate the obtained mobile device information to the identification information in the user accounts.

The authentication module may be configured to authenticate users accounts responsive to the correlation module correlating the obtained mobile device information to the identification information associated with the users in the user accounts. Responsive to user account authentication, the presentation control devices may be enabled to present views of the online game associated with the online game account information corresponding to the authenticate user accounts. Responsive to the correlation module correlating the first mobile device information associated with the first mobile device of the first user with the first identification information associated with the first user in the first user account, the first user account may be authenticated. Responsive to the authentication of the first user account, the first presentation control device may be enabled to present views of the online game to the first user. The first presentation control device may present the views of the online game to the first user.

Another aspect of the invention relates to a method for authenticating user accounts to users of presentation control devices. The method may be implemented in a computer system that includes one or more physical processors and storage media storing machine-readable instructions. The method may comprise the steps of, executing an instance of an online game, managing user information associated with the users of the online game, obtaining mobile device information from presentation control devices, correlating the obtained mobile device information with identification information in the users' accounts, authenticating users' accounts, and/or other steps and/or processes.

Executing an instance of an online game may include implementing the instance of the online game to facilitate participation of users in the online game through views of the online game presented to the users through presentation control devices and mobile devices.

Managing user information associated with the users of the online game may include managing user information including user accounts comprising identification information and online game account information. The user accounts may include a first user account comprising first identification information and first game account information associated with a first user.

Presentation control devices may be communication with mobile devices associated with the users of the presentation control devices 28 such that mobile device information obtained from the presentation control devices including first mobile device identification information obtained from a first presentation control device communicating with the first mobile device The first mobile device may be associated with the first user.

Correlating the obtained mobile device information to the identification information in the user accounts may include matching mobile device information with identification information.

Responsive to a correlation of the obtained mobile device information to the identification information associated with the users in the user accounts, the user accounts may be authenticated. Responsive to the authentication, the presentation control devices may be enabled to present views of the online game associated with online game account information of the user accounts. Responsive to correlating the first mobile device identification information associated with the first mobile device of the first user with the first identification information associated with the first user in the first user account, the first user account may be authenticated and the first presentation control device may be enabled to present views of the online game to the first user associated with first online game account information of the first user account

Another aspect of the disclosure relates to a system for presenting views of online games to users at presentation control devices. The system may comprise one or more processors configured to execute computer program modules. The computer program modules may comprise one or more of, a detection module, a receiving module, a transmission module, a game client module, and/or other modules.

The detection module may be configured to detect mobile devices within the vicinity of the presentation control devices. The mobile devices may be associated with users of an online game which are within the vicinity of the presentation control devices.

The receiving module may be configured to obtain the mobile device information associated with the users from mobile devices detected by the detection module. Responsive to the detection of a first mobile device by the detection module, the receiving module may obtain first mobile device information from the first mobile device. The first mobile device may correspond to a first user of a first presentation control device.

The transmission module may be configured to transmit the obtained mobile device information associated with users of the presentation control devices to a remote online game server. The server may use the mobile device information to authenticate the users of the presentation control devices to user accounts of the online game provided by the server. Such transmissions may include the first mobile device information obtained from the first mobile device transmitted to the server for authentication of the first user of the first presentation control device to a first user account of the online game provided by the server. The first user account may be associated with the first user.

The game client module may be configured to present views of the online game at the presentation control devices associated with the authenticated user accounts of the online game. Responsive to authentication of the users of the presentation control devises to the user accounts of the online game by the remote server, the presentation control devices may be enabled to present the views of the online game associated with game account information from the users accounts associated with the users. Responsive to authentication of the first user of the first presentation control device to the first user account of the online game by the remote server, the first presentation control device may be enabled to present views of the online game. The views may be associated with the first game account information corresponding to the first user account associated the first user.

Another aspect of the disclosure relates to a method for presenting views of online games at presentation control devices. The method may be implemented in a computer system that includes one or more physical processors and storage media storing machine-readable instructions. The method may comprise the steps of, detecting mobile devices within the vicinity of the presentation control devices, obtaining mobile device information from the detected mobile devices, transmitting the mobile device information to a remote online game server for authentication of user accounts associated with the users of the presentation control devices, presenting views of an online game at the presentation control devices, and/or other steps and/or processing.

Detecting mobile devices within the vicinity of presentation control devices may include detecting the mobile devices associated with users of an online game within the vicinity of the presentation control devices.

Obtaining mobile device information associated with users from the detected mobile devices corresponding with the users may include, responsive to a detection of a first mobile device, first mobile device information is obtained from the first mobile device. The first mobile device may correspond to a first user of a first presentation control device.

Transmitting the obtained mobile device information associated with users of the presentation control devices to a remote online game server may include the server using the mobile device information to authenticate the users of the presentation control devices to user accounts of an online game provided by the server. Such transmission may include transmitting the first mobile device information obtained from the first mobile device to the server for authentication of the first user to a first user account of an online game provided by the server. The first user account may be associated with the first user.

Responsive to authentication of the users of presentation control devises to user accounts of an online game by the remote server, presentation control devices may be enabled to present views of the online game. The views may be presented corresponding to game account information associated with the authenticated users accounts of the users. Responsive to authentication of the first user of the first presentation control device to the first user account of the online game by the remote server, the first presentation control device may be enabled to present views of the online game. The first presentation control device may present the views of the online game to the first user wherein the views may be associated with first game account information associated with the first user.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system for authenticating user accounts associated with an online game to users of presentation control devices to enable the presentation control devices to present views of the online game corresponding to the authenticated users.

FIG. 2 illustrates in more detail the system of FIG. 1.

FIG. 3 illustrates a method for authenticating users accounts associated with an online game to users of presentation control devices.

FIG. 4 illustrates a method for presenting views of an online game corresponding to users of the presentation control devices who are authenticated to user accounts associated with the online game.

### DETAILED DESCRIPTION

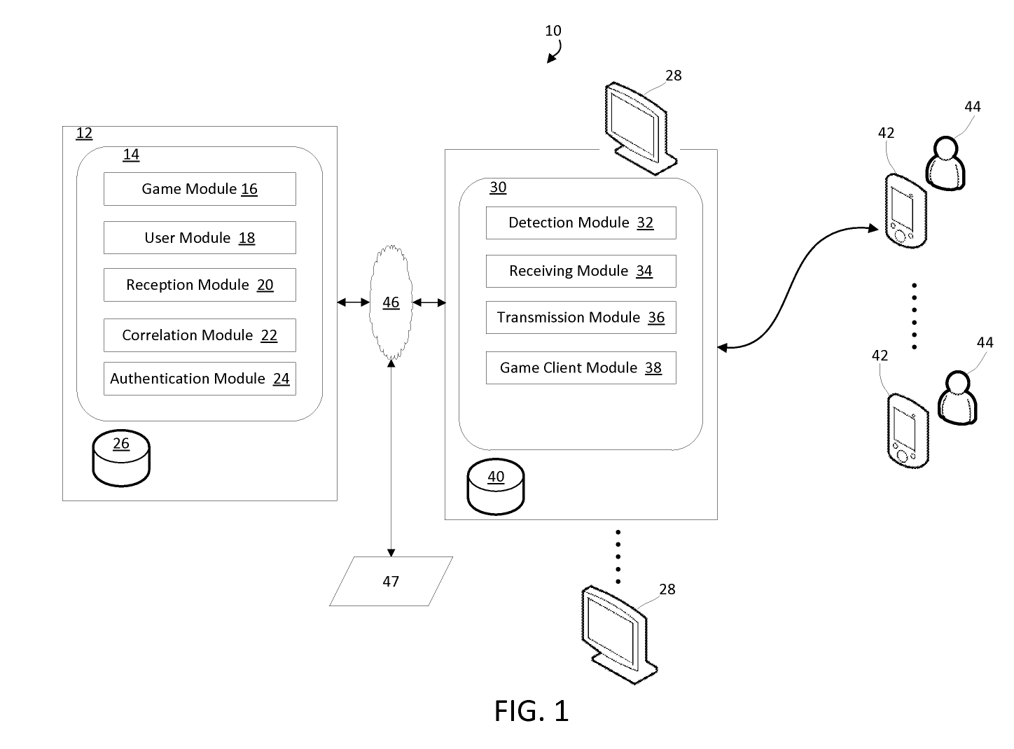

FIG. 1 illustrates a system 10 configured to dynamically authenticate users of presentation control devices 28 to user accounts hosted by one or more remote servers which are associated with the users. Authentication may be accomplished by the one or more remote servers hosting the user accounts. Presentation control devices 28 may include, for example, a television set-top box, smart TV, computer, gaming consul, and/or other device capable of network communication. The remote servers may provide a virtual environment. The virtual environment may be an on-line game. One or more remote servers may be a game server, such as game server 12.

The system 10 herein provides dynamic authentication of one or more users 44 of presentation control devices 28 to user accounts hosted by a remote server, such that responsive to a user authentication at the remote server, the presentation control devices 28 are enabled to present views of the virtual environment provided by the remote server. The users 44 may be provided access to user account information associated with the server at the presentation control devices 28. User account information may include game account information related to the users 44 and one or more online games played by the users 44. Game account information may include saved game progress, achievements, awards, virtual currency inventory, virtual item inventory, communication history, search history, and/or other information related to the one or more online games played by the users.

Presentation control devices 28 may communicate with the game server 12 over a network. Presentation control devices 28 may communicate mobile device information which is obtained from mobile devices 42 associated with the users 44 at the presentation control devices 28, to the game server 12. The game server 12 may correlate the obtained mobile device information to identification information which is stored in the user accounts by the game server 12. The identification and mobile device information may be used to correlate the users 44 with their respective remote user accounts stored by the game server 12. Correlating mobile device information with identification information may include matching the mobile device information with the identification information. Identification information may include a copy of the mobile device information and/or other information which can be used to correlate the mobile information with the identification information to correlate the users 44 of the presentation control devices 28 with respective user accounts associated with the users 44.

Mobile device information may be obtained by presentation control devices 28 in a variety of ways. Mobile device information may be obtained automatically from mobile devices 42 responsive to a detection of the mobile devices 42 within the vicinity of the presentation control devices 28. Mobile device information may be obtained by the presentation control devices 28 responsive to users 44 of the mobile devices 42 approving communication of mobile device information from the mobile devices 42 to the presentation control devices 28. For example, mobile devices 42 detected within the vicinity of presentation control devices 28 may prompted to approve communication of mobile device information to the presentation control devices 28 (e.g., by user input into the mobile device). Mobile device information may be obtained by other techniques and/or methods.

User input for approval may include, for example, the input of a security confirmation into the mobile devices 42. The security confirmation may include a confirmation of an action completed at the mobile device 42 by the user. The action to be completed at the mobile device 42 may include one or more of the users 44 performing a gesture (e.g., performing a swipe pattern on a security grid), entering a password/code, performing voice recognition, performing facial recognition and/or other action.

Mobile device information may be communicated from the presentation control devices 28 to the game server 12 for authentication by the game server 12 in a variety of ways. Mobile device information obtained from the mobile devices 42 may be automatically communicated from the presentation control devices 28 to the game server 12 for authentication. Mobile device information may be communicated to the game server 12 responsive to the users 44 of the mobile devices 42 approving communication of mobile device information from the presentation control devices 28 to the game server 12. For example, mobile devices 42 associated with the users 44 of the presentation control devices 28 may prompted to approve communication of mobile device information (e.g., by user input into the mobile device) from the presentation control devices 28 to the game server 12. Mobile device information may be communicated from the presentation control devices 28 to the game server 12 for authentication via other techniques and/or methods.

The game server 12 may correlate the obtained mobile device information to same or similar identification information present in the user accounts on the game server 12, in order to authenticate the user accounts. Authentication by the game server 12 may be accomplished in a variety of ways. Responsive to the correlation (e.g., a successful matching of the mobile device information with same or similar identification information), the game server 12 may then automatically authenticate the user accounts associated with the users 44. Responsive to the correlation, the game server 12 may authenticate the user accounts associated with the users 44 responsive to the users 44 approving authentication of the user accounts. For example, mobile devices 42 associated with the users 44 of the presentation control devices 28 may prompted to approve authentication after a successful match of the mobile device information with the identification information (e.g., by user input into the mobile device). Authentication by the game server 12 may be accomplished by other techniques and/or methods.

Responsive to user account authentication, the presentation control devices 28 associated with the authenticated users may be enabled to present views of the online game which correspond to the user's accounts. Enabling presentation control devices 28 to present views of the online game may be accomplished in a variety of ways. Responsive to the user account authentication, the presentation control devices 28 associated with authenticated users may be automatically enabled to present views of the online game at the presentation control devices 28. Responsive to user account authentication, the presentation control devices 28 may be enabled to present views of the online game responsive to the users 44 approving presentation of views of the online game by the presentation control devices 28. For example, mobile devices 42 associated with the users 44 of the presentation control devices 28 may prompted to approve the presentation of views of the online game to the presentation control devices 28 (e.g., by user input into the mobile device 42).

The views of the online game may be associated with the authenticated users 44 and corresponding user accounts. The views of the online game may facilitate user access to online game accounts associated with the authenticated users of the presentation control devices 28. Once the presentation control devices 28 are enabled to present views of the online game provided by the game server, the presentation control devices 28 may then present the views to the users 44. Presenting views of the online game may include an execution, by the game server 12, of an instance of the online game which is communicated from the server 12 to the presentation control devices 28 and which is capable of presentation at the presentation control devices 28. Presenting views of the online game to the presentation control devices 28 by the game server may include other techniques and/or methods.

In FIG. 1, providing the virtual environment may include hosting the virtual environment over a network 46, such as the Internet. A host server may include one or more processors configured to execute one or more computer modules for implementing an instance of an online game and to facilitate the participation of one or more users in the online game. The host server may be game server 12.

The computer program modules may include one or more of a game module 16, a user module 18, a reception module 20, a correlation module 22, an authentication module 24, and/or other modules. The game server 12 may be configured to communicate with one or more presentation control devices 28, according to client/server architecture. The presentation control devices 28 can include, for example, a television set-top box, smart TV, computer, gaming consul, and/or other device capable of networked communication. The users 44 may access game server 12 and/or views of the virtual environment via the presentation control devices 28.

The presentation control devices 28 may include one or more processors configured to execute one or more computer modules to facilitate communication with one or more mobile devices 42 associated with one or more users 44 of the presentation control devices 28, to communicate with one or more remote servers, to present views of an online game to the users 44 of the presentation control devices 28, and/or for other uses. The computer program modules executed by the presentation control devices 28 may include one or more of a detection module 32, a receiving module 34, a transmission module 36, a game client module 38, and/or other modules.

Referring now to the game server 12 of FIG. 1, the game module 16 may be configured to implement instances of the virtual environment (e.g., online game) executed by the computer modules to determine state of the virtual environment. The state may then be communicated (e.g., via streaming visual data, via object/position data, and/or other state information) as views of the online game to the presentation control devices 28 for presentation to users 44. The state determined and transmitted to a given presentation control device 28 may correspond to a view for a user character being controlled by a user via input devices (e.g., a controller) at the given presentation control device 28. The state determined and presented to a given presentation control device 28 may correspond to a location in the virtual environment (e.g., location in the game). The view described by the state for the given presentation control device 28 may correspond, for example, to the location from which the view is taken, the location the view depicts, and/or other locations, a zoom ratio, a dimensionality of objects, a point-of-view, and/or view parameters of the view. One or more of the view parameters may be selectable by the user.

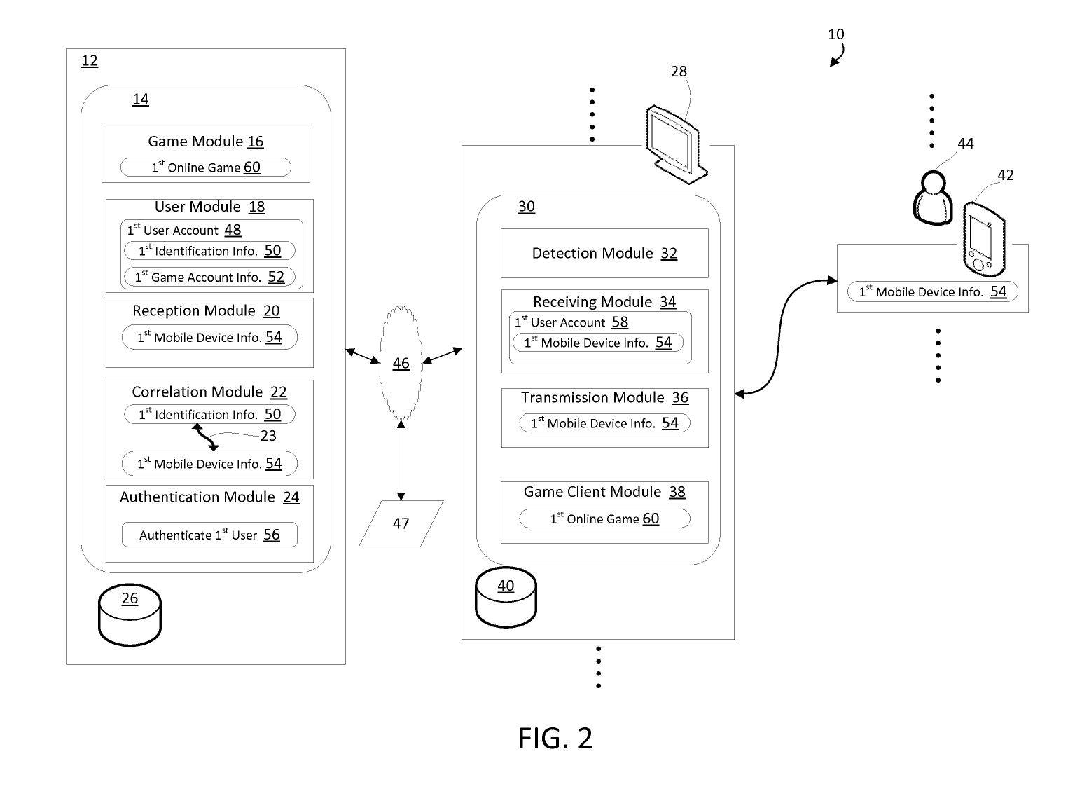

An instance of the virtual environment may comprise a simulated environment that is accessible by users via clients (e.g., presentation control devices 28) that present the views of the virtual environment to a user. The simulated environment may have a topography, express ongoing real-time interaction by one or more users, and/or include one or more objects positioned within the topography that are capable of locomotion within the topography. In some instances, the topography may be a 2-dimensional topography. In other instances, the topography may be a 3-dimensional topography. The topography may include dimensions of the environment, and/or surface features of a surface or objects that are “native” to the environment. In some instances, the topography may describe a surface (e.g., a ground surface) that runs through at least a substantial portion of the environment. In some instances, the topography may describe a volume with one or more bodies positioned therein (e.g., a simulation of gravity-deprived environment with one or more celestial bodies positioned therein). An instance executed by the computer modules may be synchronous, asynchronous, and/or semi-synchronous. For example, referring now to FIG. 2, game module 16 may execute a first instance 60 of the online game. The first instance 60 may be associated with first game account information 52 associated with a first user 44.

The above description of the manner in which state of the virtual environments is determined by game module 16 is not intended to be limiting. The game module 16 may be configured to express the virtual environment in a more limited, or more rich, manner. For example, views determined for the virtual environment representing the state of the instance of the virtual environment may be selected from a limited set of graphics depicting an event in a given place within the virtual environment. The views may include additional content (e.g., text, audio, pre-stored video content, and/or other content) that describes particulars of the current state of the place, beyond the relatively generic graphics. For example, a view may include a generic battle graphic with a textual description of the opponents to be confronted. Other expressions of individual places within the virtual environment are contemplated.

Within the instance(s) of the virtual environment executed by game module 16, users may control characters, objects, simulated physical phenomena (e.g., wind, rain, earthquakes, and/or other phenomena), and/or other elements within the virtual environment to interact with the virtual environment and/or each other. The user characters may include avatars. As used herein, the term “user character” may refer to an object (or group of objects) present in the virtual environment that represents an individual user. The user character may be controlled by the user with which it is associated. The user controlled element(s) may move through and interact with the virtual environment (e.g., non-user characters in the virtual environment, other objects in the virtual environment). The user controlled elements controlled by and/or associated with a given user may be created and/or customized by the given user. The user may have an “inventory” of virtual goods and/or currency that the user can use (e.g., by manipulation of a user character or other user controlled element, and/or other items) within the virtual environment.

Returning to FIG. 1, the users may participate in the instance of the virtual environment by controlling one or more of the available user controlled elements in the virtual environment. Control may be exercised through control inputs and/or commands input by the users 44 through presentation control devices 28. For example, the presentation control devices 28 may be a smart TV, and commands may be input by a remote control in communication with the smart TV for controlling the smart TV, and/or other controller. The users may interact with each other through communications exchanged within the virtual environment. Such communications may include one or more of textual chat, instant messages, private messages, voice communications, and/or other communications. Communications may be received and entered by the users via their respective presentation control devices 28. Communications may be routed to and from the appropriate users through server 12 (e.g., through game module 16).

The user module 18 may be configured to access and/or manage one or more user profiles and/or user information associated with the users 44 of the system 10. The one or more user profiles and/or user information may include information stored by the server 12, one or more of the presentation control devices 28, and/or other storage locations. The user profiles may include, for example, identification information for identifying users (e.g., a username or handle, numerical string, a token, a key, a password, an identifier, and/or other identifying information) within the virtual environment, security login information (e.g., a login code or password, a gesture performed on a grid, voice recognition, facial recognition, and/or other security information), virtual environment accounts (e.g., user accounts), virtual environment account information (e.g., game account information), subscription information, virtual currency account information (e.g., related to currency held in credit for a user), relationship information (e.g., information related to relationships between users in the virtual environment), virtual environment usage information, demographic information associated with users, interaction history among users in the virtual environment, information stated by users, browsing history of users, a presentation control device identification associated with a user, a phone number associated with a user, and/or other information related to users.

By way of illustration, in FIG. 2, the user module 18 may manage a first user account 48 associated with the first user 44. The first user 44 may be a user of a presentation control device, such as first presentation control device 28. The first user account 48 may include first identification information 50 which correlates the first user 44 with the first user account 48. First identification information 50 may include a copy of first mobile device information 54 containing information for identifying the first user 44. The first mobile device information 54 may be stored within a first mobile device 42 associated with the first user. First mobile device information 54 may include information which correlates the first user 44 associated with the first user account 48, and/or other information. First identification information 50 and first mobile device information 54 may include other information which correlates the first user 44 with the first user account 48. The first user account 48 may include first game account information 52. The first game account information may correspond to information regarding one or more online games hosted by the game server 12 and/or other servers which are played by the first user 44.

Returning to FIG. 1, reception module 20 may be configured to obtain mobile device information from the presentation control devices 28. Mobile device information may correspond with mobile devices 42 associated with the users 44 of presentation control devices 28. The mobile device information may be obtained by and stored within the presentation control devices 28. Mobile device information may correlate users 44 with user accounts within the game server 12 (e.g., user module 18). Obtaining mobile device information by reception module 20 may include the reception module 20 receiving and/or retrieving the mobile device information from the presentation control devices 28, and/or by other methods and/or techniques.

Reception module 20 may receive the mobile device information in a variety of ways. Reception module 20 may automatically receive the mobile device information from presentation control devices 28, reception module 20 may only receive the mobile device information from the presentation control devices 28 after the presentation control devices 28 are prompted to send the mobile device information, and/or reception module 20 may receive and/or retrieve the mobile device information by other techniques.

Mobile device information may be received by reception module 20 from presentation control devices 28 automatically. Reception module 20 may automatically receive the mobile device information from the presentation control devices 28 once the presentation control devices 28 obtain the mobile device information (e.g., from the mobile devices 42 associated with the users 44 of the presentation control devices 28, described in more detail later).

Mobile device information may be received by reception module 20 from the presentation control devices 28 after the presentation control devices 28 are prompted to send the mobile device information. Presentation control devices 28 may be prompted to send the mobile device information responsive to users 44 of the presentation control devices 28 approving communication of the mobile device information from the presentation control devices 28 to the game server 12 (e.g., reception module 20). For example, mobile devices 42 associated with the users 44 of the presentation control devices 28 may be prompted (e.g., via a pop-up window, instant message, electronic mail message, and/or other technique) to approve communication of mobile device information from the presentation control devices 28 to the reception module 20 (e.g., by user input into the mobile device 42).

Mobile device information may be retrieved from the presentation control device 28 by the server 12 (e.g., by reception module 20). For example, users 44 of presentation control devices 28 may make a selection at the presentation control devices 28 to play an online game (e.g., a virtual environment provided by the server 12). The presentation control device 28 may communicate over a network (e.g., network 26) with the server hosting the online game (e.g. server 12) to initiate presentation of the game. Prior to, or concurrently with the server presenting the online game to the presentation control device 28, reception module 20 may retrieve mobile device information from the presentation control device 28.

By way of illustration, returning to FIG. 2, reception module 20 may include first mobile device information 54 which may be obtained from the first presentation control device 28 associated with the first user 44. First mobile device information 54 may correspond to the first mobile device 42 associated with the first user 42 of the first presentation control device 28. First mobile device information 54 may include information which is the same as or similar to the first identification information 50 within user module 18, and/or other information. For example, both first mobile device information 54 and first identification information 50 may include one or more of a user name, numerical string, a token, a key, and a password, associated with the first user 44.

Returning to FIG. 1, correlation module 22 may be configured to correlate the mobile device information obtained by the reception module 20 to the identification information stored in the user accounts within the user module 18. Correlation may be accomplished in a variety of way, including exactly matching the mobile device information with the identification information, matching a portion and/or a substantial portion of the mobile device information with the identification information, and/or by other techniques.

By way of illustration, in FIG. 2, correlation module 22 may correlate 23 the first mobile device information 54 with the first identification information 50 by matching all or a portion of the first mobile device information 54 with the first identification information 50. For example correlation module 22 may correlate 23 the first mobile device information 54 with the first identification information 50 by matching all or a portion of a user name, numerical string, a token, a key, and a password, associated with the first user 44 and contained within both of the first mobile device information 54 and first identification information 50. Correlation module 22 may correlate 23 by other methods and/or techniques.

Returning to FIG. 1, authentication module 24 may be configured to authenticate user accounts. Authentication module 24 may be configured to authenticate user accounts responsive to the correlation module 22 successfully correlating the obtained mobile device information to the identification information stored in the user accounts in the user module 18. Authentication module 24 may be configured to authenticate user accounts in a variety of ways. Responsive to the correlation (e.g., a successful match), the authentication module 24 may be configured to automatically authenticate the user accounts, and/or authenticate the user accounts responsive to user input, and/or authenticate the user accounts in other ways.

Responsive to the correlation (e.g., a successful match), the authentication module 24 may authenticate the user accounts responsive to user input approving the authentication of the user accounts. For example, mobile devices 42 associated with the users 44 of the presentation control devices 28 may prompted to approve authentication of user accounts after a successful match of the mobile device information with the identification information by correlation module 22 (e.g., by user input into the mobile device).

The authentication module 24 may be configured such that responsive to the authentication of the user accounts, the presentation control devices 28 are enabled to present views of the online game. Enabling presentation control devices 28 to present views of the online game may be accomplished in a variety of ways. Responsive to the authentication of the user accounts, the presentation control devices 28 may be automatically enabled to present views of the online game. Responsive to the authentication of the user accounts, the presentation control devices 28 may be enabled to present views of the online game responsive to the users approving the presentation of views of the online game at the presentation control device. For example, mobile devices 42 associated with the users 44 of the presentation control devices 28 may prompted for user input to approve the presentation of views of the online game at the presentation control devices 28 after the authentication of the user accounts by authentication module 24 (e.g., by user input into the mobile device 42).

User input for approval may include, for example, the input of a security confirmation into the mobile devices 42. The security confirmation may include a confirmation of an action completed at the mobile device 42 of the user of the presentation control device 28. The action to be completed at the mobile device 42 may include one or more of the user performing a gesture (e.g., performing a swipe pattern on a graphical interface of the mobile device), entering a password or code, performing voice recognition, performing facial recognition and/or other action. The confirmation of the action may be accomplished by recognition of the action by the user module 18 of the action (e.g., user module 18 stores one or more actions which may be set or predetermined for the users).

Enabling the presentation control devices 28 to present views of the online game may include for example, an execution by the game module 16 of an instance of the online game which is capable of presentation by the presentation control devices 28, and/or other technique. The instance of the online game executed by game module 16 may correspond to game account information associated with the authenticated users. For example the instance of the online game presented to the presentation control devices 28 by game module 16 may including providing access to game account information corresponding to the authenticated user such as saved game progress, achievements, awards, virtual currency inventory, virtual item inventory, communication history, search history, and/or other information related to the one or more online games played by the users.

By way of example, in FIG. 2 responsive to the correlation module 22 correlating 23 the first mobile device information 54 associated with the first mobile device 42 of the first user 44 of the first presentation control device 28 with the first identification information 50 associated with the first user 44 in the first user account 48, the first user account 48 may be authenticated 56. Responsive to the authentication 56, the first presentation control device 28 may be enabled to present views of the online game to the first user 44. The first presentation control device 28 may present the views of the online game to the first user 44. The views of the online game may correspond with the first online game account information 52 corresponding to the first user 44. Views of the online game may be provided by the first instance 60 of the online game executed by game module 16 which is capable of presentation by first presentation control device 28.

Returning to FIG. 1, referring now to processes performed by presentation control devices 28, the detection module 32 may be configured to detect mobile devices 42 of the users 44 of presentation control devices 28 within the vicinity of the presentation control devices 28. Detection may be accomplished by one or more of using near field communication (NFC) capabilities, Bluetooth®, wifi capabilities, and/or other wireless communication capabilities of the presentation control devices 28. Detection of the mobile devices 42 may be accomplished in a variety of ways, including automatically, by user selection at the presentation control devices 28, and/or by other techniques.

Detection of mobile devices 42 by detection module 32 which is automatic may be accomplished in a variety of ways. Presentation control devices 28 (e.g., detection module 32) may perform automatic network searches for detecting the presence of mobile devices 42 within the capable communication ranges of the presentation control devices 28. Detection module 32 may automatically detect mobile devices 42 responsive to the mobile devices 42 sending communication signals (e.g., radio frequency signals) to communicate their presence within the vacuity of the presentation control devices 28.

Automatic network searches performed by the detection module 32 may be performed at a frequency or rate which is predetermined by the presentation control devices 28, set by the user, and/or continuous (e.g., always searching). For example, a predetermined frequency of which detection module 32 performs searches to detect mobile devices may be set to every 10 minutes (or other frequency). A user may set the frequency and/or other parameters (e.g., a time period) to set rules for when the detection module 32 searches for mobile devices 42 within the vicinity of the presentation control devices 28. For example, a user may make selections at the presentation control devices 28 (e.g., within an application program in the presentation control devices 28) wherein the presentation control devices 28 perform mobile device 42 detection searches every 30 minutes, continuously after a given time period (e.g., when the user expects to be within the vicinity of the presentation control devices 28), and/or other frequency or parameter selection.

Users within the vicinity of presentation control devices 28 may send communication signals (e.g., radio frequency signals via NFC, Bluetooth, and/or wifi) to communicate their presence when within the vacuity of the presentation control devices 28. For example, a user may make a selection on their mobile device 42 to ping the presentation control devices 28 to initiate detection by the presentation control devices 28 of the mobile device 42 and/or multiple mobile devices within the vicinity of the presentation control devices 28.

Detection of mobile devices 42 by detection module 32 may be accomplished by user selection at the presentation control devices 28. For example, users may make selections at the presentation control device 28 (e.g., via an application program provided by the presentation control devices 28) to initiate detection (e.g., start looking for mobile devices within the vicinity) of user mobile devices 42 by the presentation control devices 28 (e.g., detection module 32).

By way of illustration, in FIG. 2, the detection module 32 of the first presentation control device 28 may detect the first mobile device 42 within the vicinity of first presentation control device 28 using NFC, wifi, and/or other communication capabilities of the first presentation control device 28.

Returning to FIG. 1, responsive to detection by the detection module 32 of mobile devices 42 within the vicinity of presentation control devices 28, the receiving module 34 may be configured to obtain the mobile device information from the mobile devices 42 associated with the users 44. Mobile device information may be obtained in a variety of ways. Receiving module 34 may obtain mobile device information by receiving the information from the mobile devices 42, retrieving the mobile device information from the mobile devices 42, and/or obtain the mobile device information by other techniques.

Receiving module 34 may receive the mobile device information responsive to the mobile devices 42 sending the mobile device information to the presentation control devices 28 (e.g., via NFC and/or wifi). For example, responsive to a detection by detection module 32 of the mobile devices 42, the users 44 of the mobile devices 42 may approve sending mobile device information to the presentation control devices 28 (e.g., by user selection within the mobile device 42), and/or responsive to the detection, mobile devices 42 may automatically send mobile device information to the presentation control devices 28 (e.g., receiving module 34).

Receiving module 34 may retrieve the mobile device information from the mobile devices 42. For example, responsive to a detection of mobile devices 42 by detection module 32, receiving module 34 may automatically retrieve information from the mobile devices 42, and/or receiving module 34 may retrieve mobile device information from the mobile devices 42 responsive to the users 44 approving retrieval of mobile device information from the mobile devices 42 (e.g., by user input into the mobile device 42).

Receiving module 34 may create and/or store user information and/or user accounts associated with the users of the presentation control device 28. The user accounts within the presentation control devices 28 may be used to store the mobile device information obtained from the mobile device 42. The user accounts may be stored and maintained within the presentation control devices 28 (e.g., the presentation control device is user's personal presentation control device and/or a presentation control device frequently used by the user), and/or user accounts may be deleted after a user has left the vicinity of the presentation control device or after some other time period (e.g., for user with a publicly used presentation control device wherein the user does not want personal information to be stored).

By way of illustration, in FIG. 2, responsive to detection of the first mobile device 42 by the detection module 32, the receiving module 34 may obtain the first mobile device information 54 from the first mobile device 42 corresponding to the first user 44 of the first presentation control device 28. Receiving module 34 may create and/or contain a first user account 58 associated with the first user 44. The first user account 58 may be used to store the first mobile device information 54 obtained from the first mobile device 42. The first user account 58 may be maintained by first presentation control device 28 (e.g., first presentation control device 28 is first user's 44 personal presentation control device or a presentation control device frequently used by the first user 44). The first user account 58 may be deleted after the first user 44 has left the vicinity of the first presentation control device 28.

Returning to FIG. 1, transmission module 36 may be configured to transmit the obtained mobile device information (e.g., obtained by receiving module 34) associated with users 44 of the presentation control devices 28 to a remote online game server (e.g., game server 12), such that the server can use the mobile device information to authenticate (e.g., by authentication module 24) the users 44 of the presentation control devices 28 to user accounts (e.g., in user module 48) of the online game provided by the server. Transmission of mobile device information may include communication over a network, such as network 46, and/or other communication network.

By way of illustration, in FIG. 2, transmission of mobile device information by transmission module 36 may include transmitting the first mobile device information 54 to the server (e.g., game server 12) for authentication by the server of the first user 44 of the first presentation control device 28 to the first user account 48 within the server.

Returning to FIG. 1, responsive to an authentication by the remote server (e.g., game server 12) of the users of presentation control devices 28 to user accounts stored within the remote server, the presentation control devices 28 may be enabled to present views of the online game provided by the remote server. Game client module 38 may be configured to present the views of the online game to the users 44 at the presentation control devices 28. Presenting views of the online game at the presentation control devices 28 may include an execution, by the game server, of an instance of the online game which is communicated from the server 12 to the presentation control devices 28 which is capable of presentation at the presentation control devices 28 (e.g., by game client module 38). The views may be associated with the game account information corresponding to the user accounts within game server. Presenting views of the online game to the presentation control devices 28 by the game server may include other techniques and/or methods.

By way of illustration, in FIG. 2, responsive to authentication of the first user 44 of the first presentation control device 28 to the first user account 48 of the online game by the remote server 12 (e.g., by authentication module 24), the first presentation control device 28 is enabled to present views of the online game, and the views are presented to the users at the presentation control devices 28 by game client module 38. Presenting views of the online game at the first presentation control device 28 may include an execution, by the game server, of a first instance 60 of the online game which is communicated from the server 12 to the first presentation control device 28 which is capable of presentation at the first presentation control device 28. The views may be associated with the first game account information 52 corresponding to the first user account 48 of the first user 44 stored within game server 12.

The server 12, presentation control devices 28, mobile devices 42, and/or external resources 47 may be operatively linked via one or more electronic communication links. For example, such electronic communication links may be established, at least in part, via a network 46 such as the Internet and/or other networks, such as near field communication, Bluetooth®, and/or wifi. It will be appreciated that this is not intended to be limiting, and that the scope of this disclosure includes implementations in which servers 12, presentation control devices 28, mobile devices 42, and/or external resources 47 may be operatively linked via some other communication media.

The external resources 47 may include sources of information, hosts and/or providers of virtual environments outside of system 10, external entities participating with system 10, and/or other resources. In some implementations, some or all of the functionality attributed herein to external resources 47 may be provided by resources included in system 10.

The server 12 and presentation control devices 28 may include electronic storage 26, 40, respectively, one or more processors 14, 30 respectively and/or other components. The server 12 and/or presentation control devices 28 may include communication lines, or ports to enable the exchange of information with a network and/or other computing platforms. Illustration of server 12 and presentation control devices 28 in FIG. 1 is not intended to be limiting. The server 12 and presentation control devices 28 may include a plurality of hardware, software, and/or firmware components operating together to provide the functionality attributed herein to the server 12 and presentation control devices 28 respectively. For example, server 12 may be implemented by a cloud of computing platforms operating together as server 12.

Electronic storage 26, 40 may comprise electronic storage media that electronically stores information. The electronic storage media of electronic storage 26, 40 may include one or both of system storage that is provided integrally (i.e., substantially non-removable) with server 12 and presentation control devices 28, respectively, and/or removable storage that is removably connectable to server 12 and presentation control devices 28 respectively, via, for example, a port (e.g., a USB port, a firewire port, etc.) or a drive (e.g., a disk drive, etc.). Electronic storage 26, 40 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storage 26, 40 may include one or more virtual storage resources (e.g., cloud storage, a virtual private network, and/or other virtual storage resources). Electronic storage 26, 40 may store software algorithms, information determined by processors 14, 30, respectively, information received from server 12, information received from presentation control devices 28, and/or other information that enables server 12 and presentation control devices 28 to function as described herein.

Processor(s) 14, 30 are configured to provide information processing capabilities in server 12 and presentation control devices 28, respectively. As such, processors 14, 30 may include one or more of a digital processor, an analog processor, a digital circuit designed to process information, an analog circuit designed to process information, a state machine, and/or other mechanisms for electronically processing information. Although processors 14 and 30 are shown in FIG. 1 as respective single entities, this is for illustrative purposes only. In some implementations, processor 14 and/or 30 may include one or more processing units. These respective processing units may be physically located within the same device, or processor 14 and/or 30 may represent processing functionality of a plurality of devices operating in coordination. The processor 14 may be configured to execute modules 16, 18, 20, 22, 24. Processor 14 may be configured to execute modules 16, 18, 20, 22, 24 by software; hardware; firmware; some combination of software, hardware, and/or firmware; and/or other mechanisms for configuring processing capabilities on processor 14. The processor 30 may be configured to execute modules 32, 34, 36, 38. Processor 30 may be configured to execute modules 32, 34, 36, 38 by software; hardware; firmware; some combination of software, hardware, and/or firmware; and/or other mechanisms for configuring processing capabilities on processor 30.

It should be appreciated that although modules 16, 18, 20, 22, 24 and 32, 34, 36, 38 are illustrated in FIG. 1 as being co-located within respective single processing units, in implementations in which processor 14 and/or 30 include multiple processing units, one or more of modules 16, 18, 20, 22, 24 and 32, 34, 36, 38 may be located remotely from the other modules. The description of the functionality provided by the different modules 16, 18, 20, 22, 24 and 32, 34, 36, 38 described above is for illustrative purposes, and is not intended to be limiting, as any of modules 16, 18, 20, 22, 24 and 32, 34, 36, 38 may provide more or less functionality than is described. For example, one or more of modules 16, 18, 20, 22, 24 and/or 32, 34, 36, 38 may be eliminated, and some or all of its functionality may be provided by other ones of modules 16, 18, 20, 22, and/or 24 and 32, 34, 36, and/or 38, and/or other modules. As another example, processor 14 may be configured to execute one or more additional modules that may perform some or all of the functionality attributed below to one of modules 16, 18, 20, 22, 24.

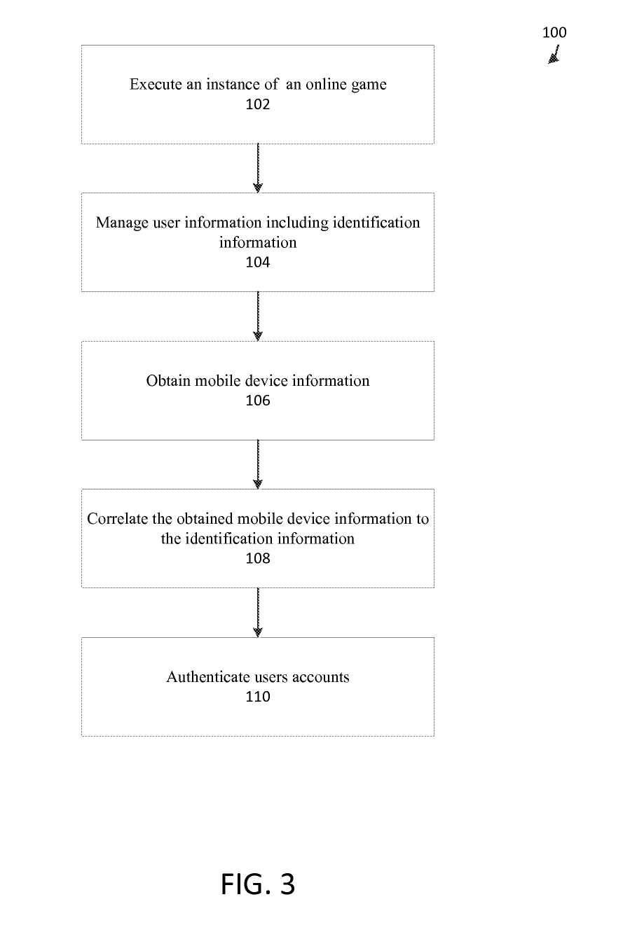

FIG. 3 illustrates a method 100 of authenticating online user game accounts from users at presentation control devices. The operations of method 100 presented below are intended to be illustrative. In some embodiments, method 100 may be accomplished with one or more additional operations not described, and/or without one or more of the operations discussed. Additionally, the order in which the operations of method 100 are illustrated in FIG. 3 and described below are not intended to be limiting.

In some embodiments, method 100 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 100 in response to instructions stored electronically on an electronic storage medium. The one or more processing devices may include one or more devices configured through hardware, firmware, and/or software to be specifically designed for execution of one or more of the operations of method 100.

Referring now to method 100 in FIG. 3, at an operation 102 an instance of an online game is executed. The online game may facilitate participation of users in the online game through views of the online game presented to the users through presentation control devices and mobile devices. In some implementations, operation 102 may be performed by a game module the same as or similar to game module 16 (shown in FIG. 1 and described herein).

At an operation 104, user information may be managed. The user information may include user accounts comprising identification information and online game account information. The user account may include a first user account comprising first identification information and first game account information associated with a first user. In some implementations, operation 104 may be performed by a user module the same as or similar to the user module 18 (shown in FIG. 1 and described herein).

At an operation 106, mobile device information may be obtained from mobile devices corresponding to users in communication with presentation control devices. The mobile device information may include first mobile device identification information obtained from a first presentation control device communicating with a first mobile device. The first mobile device may be associated with the first user. In some implementations, operation 106 may be performed by a reception module the same as or similar to reception module 20 (shown in FIG. 1 and described herein).

At an operation 108, the mobile device information obtained at operation 106 may be correlated with the identification information stored in the user accounts which are managed at operation 104. Correlation may include matching the mobile device information with the identification information. In some implementations, operation 108 may be performed by correlation module the same as or similar to correlation module 22 (shown in FIG. 1 and described herein).

At an operation 110, user accounts may be authenticated. Account may be authenticated responsive to the correlation at operation 108. Responsive to correlating the obtained mobile device information to the identification information associated with the users in the user accounts, the user accounts may be authenticated, and responsive to the authentication, the presentation control device may be enabled to present views of the online game associated with online game account information of the user accounts. Responsive to correlating the first mobile device identification information associated with the first mobile device of the first user with the first identification information associated with the first user in the first user account, the first user account may be authenticated and the first presentation control device may be enabled to present views of the online game to the first user associated with first online game account information of the first user account. In some implementations, operation 110 may be performed by an authentication module the same as or similar to authentication module 24 (shown in FIG. 1 and described herein).

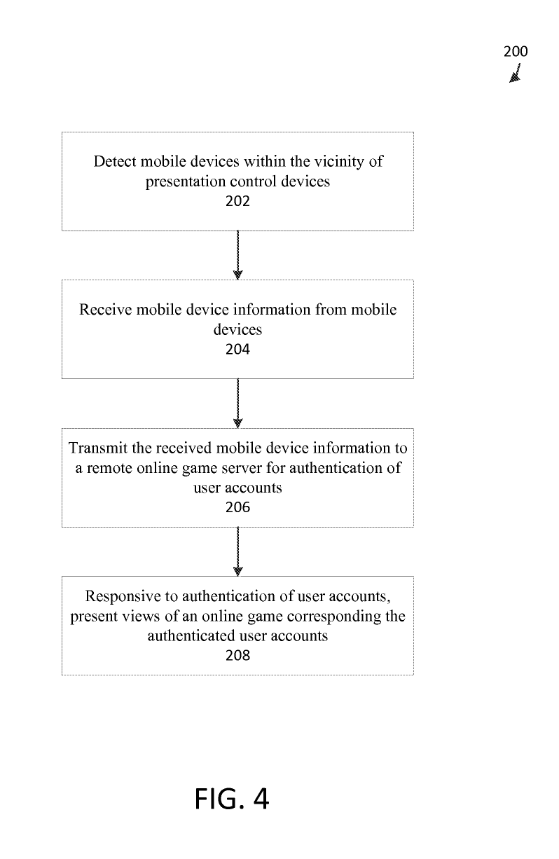

FIG. 4 illustrates a method 200 for presenting views of online games at presentation control devices. The operations of method 200 presented below are intended to be illustrative. In some embodiments, method 200 may be accomplished with one or more additional operations not described, and/or without one or more of the operations discussed. Additionally, the order in which the operations of method 200 are illustrated in FIG. 4 and described below are not intended to be limiting.

In some embodiments, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 100 in response to instructions stored electronically on an electronic storage medium. The one or more processing devices may include one or more devices configured through hardware, firmware, and/or software to be specifically designed for execution of one or more of the operations of method 100.

Referring now to method 200 in FIG. 4, mobile devices within the vicinity of presentation control devices may be detected. Detection may be accomplished via NFC and/or wifi capabilities of the presentation control devices. In some implementations, operation 202 may be performed by a detection module the same as or similar to detection module 32 (shown in FIG. 1 and described herein).

At an operation 204, mobile device information may be obtained from the mobile devices detected at operation 202 and stored in presentation control devices. Mobile device information 54 may be received, retrieved, and/or obtained by the presentation control devices by other techniques. Responsive to a detection of a first mobile device, first mobile device information may be obtained; the first mobile device information may correspond to the first mobile device associated with a first user. In some implementations, operation 204 may be performed by a receiving module the same as or similar to receiving module 34 (shown in FIG. 1 and described herein).

At an operation 206, the obtained mobile device information is transmitted to a remote online game server. The server may use the mobile device information to authenticate the users of the presentation control devices to user accounts of an online game provided by the server. Such transmission may include transmitting the first mobile device information obtained from the first mobile device for authentication of the first user of a first presentation control device to a first user account of an online game hosted by the server. The first user account may be associated with the first user. In some implementations, operation 206 may be performed by a transmission module the same as or similar to transmission module 36 (shown in FIG. 1 and described herein).

At an operation 208, the presentation control devices present views of the online game to the users of the presentation control devices. Such that responsive to authentication of the users of presentation control devises to user accounts of an online game by the remote server, views are presented corresponding to game account information associated with the users accounts of the users. Responsive to authentication of the first user of the first presentation control device to the first user account of the online game by the remote server, the first presentation control device presents views of the online game associated with first game account information from the first user account associated with the first user. In some implementations, operation 208 may be performed by a game client module the same as or similar to game client module 38 (shown in FIG. 1 and described herein).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system for authenticating user accounts to users of presentation control devices, the system comprising:
one or more processors configured to execute computer program modules, the computer program modules comprising:
a game module configured to execute an instance of an online game, and to implement the instance of the online game to facilitate participation of users in the online game through views of the online game presented to the users through presentation control devices and mobile devices;
a user module configured to manage user information associated with the users of the online game, the user information including user accounts comprising identification information and online game account information, the user accounts including a first user account comprising first identification information and first game account information associated with a first user;
a reception module configured to obtain mobile device information from presentation control devices in communication with mobile devices associated with the users, the mobile device information including first mobile device identification information obtained from a first presentation control device communicating with a first mobile device, the first mobile device being associated with the first user;
a correlation module configured to correlate the obtained mobile device information to the identification information in the user accounts;
an authentication module configured to authenticate users accounts, such that responsive to the correlation module correlating the obtained mobile device information to the identification information associated with the users in the user accounts, the user accounts are authenticated, and responsive to the authentication, the presentation control devices are enabled to present views of the online game associated with the online game account information of the user accounts, such that, responsive to the correlation module correlating the first mobile device information associated with the first mobile device of the first user with the first identification information associated with the first user in the first user account, the first user account is authenticated and the first presentation control device is enabled to present views of the online game to the first user.

2. The system of claim 1 wherein the user module is further configured such that identification information includes one or more of a user name, numerical string, a token, a key, and a password, associated with the users; and the reception module is further configured such that mobile device information includes one or more of a user name, numerical string, a token, a key, and a password, associated with the users.

3. The system of claim 1 wherein the correlation module is further configured such that the correlation includes matching the mobile device information obtained by the reception module to the identification information in the user accounts in the user module.

4. The system of claim 1 wherein the authentication module is further configured such that enabling presentation control devices to present views of the online game associated with the online game account information of the user accounts includes the game module executing an instance of an online game which is capable of presentation by the presentation control devices, the instance of the online game corresponding to online game account information associated with the users of the presentation control devices to facilitate user access to the online game account information at the presentation control devices, such that enabling the first presentation control device to present views of the online game to the first user includes the game module executing a first instance of the online game which is capable of presentation by the first presentation control device, wherein the first instance corresponds to the first online game account information associated with the first user of the first presentation control device.

5. The system of claim 4 wherein the authentication module is configured such that prior to enabling presentation control devices to present views of the online game, the authentication module receives from the presentation control device a security confirmation obtained from the mobile devices associated with the users of the presentation control devices.

6. The system of claim 5 wherein the authentication module is configured such that the security confirmation includes a confirmation of an action completed at the mobile device of the user of the presentation control device.

7. The system of claim 6 wherein the authentication module is configured such that the action completed at the mobile device includes one or more of the users performing a gesture, entering a password, performing voice recognition, and performing facial recognition.

8. A method for authenticating user accounts to users of presentation control devices, the method being implemented in a computer system that includes one or more physical processors and storage media storing machine-readable instructions, the method comprising:
executing an instance of an online game, including implementing the instance of the online game to facilitate participation of users in the online game through views of the online game presented to the users through presentation control devices and mobile devices;
managing user information associated with the users of the online game, the user information including user accounts comprising identification information and online game account information, the user accounts including a first user account comprising first identification information and first game account information associated with a first user;
obtaining mobile device information from the presentation control devices in communication with the mobile devices associated with the users, the mobile device information including first mobile device identification information obtained from a first presentation control device communicating with a first mobile device, the first mobile device being associated with the first user;
correlating the obtained mobile device information to the identification information in the user accounts;
authenticating users accounts, such that responsive to correlating the obtained mobile device information to the identification information associated with the users in the user accounts, the user accounts are authenticated, and responsive to the authentication, the presentation control device is enabled to present views of the online game associated with online game account information of the user accounts such that, responsive to correlating the first mobile device identification information associated with the first mobile device of the first user with the first identification information associated with the first user in the first user account, the first user account is authenticated and the first presentation control device is enabled to present views of the online game to the first user associated with first online game account information of the first user account.

9. The method of claim 8 wherein the identification information and mobile device information include one or more of a user name, numerical string, a token, a key, and a password, associated with the users at the presentation control devices.

10. The method of claim 8 wherein correlating the obtained mobile device information to the identification information in the user accounts includes matching the obtained mobile device information to the identification information in user accounts in the user module.

11. The method of claim 8 wherein enabling presentation control devices to present views of the online game includes executing an instance of an online game which is capable of presentation by the presentation control devices, wherein the instance of the line game corresponds to online game account information associated with the users of the presentation control devices to facilitate user access to the online game account information at the presentation control devices, such that enabling the first presentation control device to present views of the online game to the first user includes executing an first instance of the online game, wherein the first instance of the online game corresponds to the first online game account information associated with the first user of the first presentation control device.

12. The method of claim 11 wherein prior to enabling presentation control devices to present views of the line game, the method further includes; receiving from the presentation control device a security confirmation obtained from the mobile devices associated with the users of the presentation control devices.

13. The method of claim 12 wherein the security confirmation includes a confirmation of an action completed at the mobile device of the user associated with the presentation control device.

14. The method of claim 13 wherein the action completed at the mobile device includes one or more of the user entering a gesture, entering a password, performing voice recognition, and performing facial recognition.

15. A system for presenting views of online games at presentation control devices, the system comprising;
one or more processors configured to execute computer program modules, the computer program modules comprising:
a detection module configured to detect mobile devices within the vicinity of presentation control devices, the mobile devices associated with users of an online game;
a receiving module configured to obtain the mobile device information associated with the users from mobile devices detected by the detection module and corresponding with the users, such that responsive to detection of a first mobile device by the detection module, the receiving module obtains first mobile device information from the first mobile device, the first mobile device corresponding to a first user;
a transmission module configured to transmit the obtained mobile device information associated with users of the presentation control devices to a remote online game server, the server using the mobile device information to authenticate the users of the presentation control devices to user accounts of the online game provided by the server, such transmissions including the first mobile device information obtained from the first mobile device transmitted for authentication of the first user of a first presentation control device to a first user account of the online game provided by the server, the first user account associated with the first user;
a game client module configured to present views of the online game at the presentation control devices associated with the user accounts of the online game, such that responsive to authentication of the users of the presentation control devises to the user accounts of the online game by the remote server, the presentation control devices is enabled to present the views of the online game associated with game account information from the users accounts associated with the users, including responsive to authentication of the first user of the first presentation control device to the first user account of the online game by the remote server, the first presentation control device is enabled to present views of the online game, the views associated with the first game account information from the first user account of the first user.

16. The system of claim 15 wherein the detection module is further configured such that detecting the mobile devices within the vicinity of presentation control devices includes using one or more of near field communication or wireless local area network communication capabilities of the presentation control devices.

17. The system of claim 15 wherein the receiving module is further configured such that mobile device information includes one or more of a user name, numerical string, a token, a key, and a password, associated with the users of the mobile devices.

18. The system of claim 15 wherein the game client module is further configured such that presenting views of an online game to the presentation control device includes an execution by the game server of an instance of the online game.

19. A method for presenting views of online games at presentation control devices, the method being implemented in a computer system that includes one or more physical processors and storage media storing machine-readable instructions, the method comprising:
detecting mobile devices within the vicinity of presentation control devices, the mobile devices associated with users of an online game;
obtaining mobile device information associated with users from the detected mobile devices corresponding with the users, such that responsive to detection of a first mobile device, obtaining first mobile device information from the first mobile device, the first mobile device corresponding to a first user;
transmitting the obtained mobile device information associated with users of the presentation control devices to a remote online game server, the server using the mobile device information to authenticate the users of the presentation control devices to user accounts of an online game provided by the server, including transmitting the first mobile device information obtained from the first mobile device for authentication of the first user of a first presentation control device to a first user account of an online game by the server, the first user account associated with the first user;
presenting views of an online game at the presentation control devices associated with user accounts of the online game, such that responsive to authentication of the users of presentation control devises to user accounts of an online game by the remote server, presentation control devices are enabled to present views of the online game and views are presented corresponding to game account information associated with the users accounts of the users, including responsive to authentication of the first user of the first presentation control device to the first user account of the online game by the remote server, the first presentation control device is enabled to present views of the online game and presents the views of the online game, the views associated with first game account information from the first user account associated with the first user.

20. The method of claim 19 wherein detecting the mobile devices within the vicinity of presentation control devices includes using one or more of near field communication or wireless local area network communication capabilities of the presentation control devices.

21. The method of claim 19 wherein the mobile device information includes one or more of a user name, numerical string, a token, a key, and a password, associated with the users of the mobile devices.

22. The method of claim 19 wherein presenting views of an online game by the presentation control device includes the game server executing an instance of the online game which is capable of presentation by the presentation control device.
